(19) United States
(12) Patent Application Publication
(10) Pub. No.: US 2004/0136366 A1
(43) Pub. Date: Jul. 15, 2004

(54) Circuit arrangement for connecting several trunk lines via PCM circuits (data transmission circuits for pulse code modulated signals) with an exchange-internal switching network, for use in a switching-oriented system

(75) Inventor: Werner Nagler, Hohenschaftlarn (DE)

Correspondence Address: Kevin R. Spivak, Morrison & Foerster LLP, Suite 300, 1650 Tysons Boulevard, McLean, VA, 22102, US

(73) Assignee: Siemens Aktiengesellschaft, Munchen (DE)

(21) Appl. No.: 10/674,819

(22) Filed: Oct. 1, 2003

(30) Foreign Application Priority Data
Oct. 2, 2002 (DE) 102 46 105.8

(51) Int. Cl. H04Q 11/00; H04L 12/50

(52) U.S. Cl. 370/362

(57) ABSTRACT

The invention relates to a circuit arrangement for connecting several trunk lines via PCM circuits to an exchange-internal switching network, for use in a switching-oriented system, preferably in an electronic data switching system, with at least two line and trunk groups, that form a redundancy pair and have at least one cross-connection, with each line and trunk group having at least one central controller, at least one interface to the exchange-internal switching network, a line circuit area for the PCM circuits and at least one transformer/framer for synchronization for each PCM circuit, with the switching arrangement being configured in such a way that a fault occurring in the circuit arrangement affects only a maximum of two PCM circuits. The invention is characterized in that switching elements, that directly and asynchronously select the PCM circuits individually and one of the two central controllers optionally, are positioned before the transformers/framers.

### CLAIM FOR PRIORITY

This application claims the benefit of priority to DE 102 46 105.8, filed on Oct. 2, 2002, in the German language, the contents of which are hereby incorporated by reference.

### TECHNICAL FIELD OF THE INVENTION

The invention relates to a circuit arrangement for connecting trunk lines via PCM circuits with a switching network within the exchange, for use in a switching-oriented system.

### BACKGROUND OF THE INVENTION

European patent application 0 291 791 B1 discloses a circuit arrangement. An embodiment of this type of circuit arrangement is described in FIG. 1 of this application. With this circuit arrangement, two controllers for the line and trunk groups LTG-X and LTG-Y operate together in a pair in a redundancy mode. In the event of a controller failure, the LTG that is still active takes over the function of the failed controller. Each of these line and trunk groups is designed for a total of five PCM 24 circuits. A requirement for the circuit arrangement states that in the event of a fault occurring a maximum of two of these PCM 24 circuits may be affected. For this reason, the five PCM 24 circuits are distributed over several interface assemblies. The requirement that a maximum of two PCM circuits may fail means for a line and trunk group that where a total of five PCM circuits per LTG are to be connected these PCM circuits are distributed over three complete interface assemblies, known as digital interface units (DIU).

Due to the required redundancy, many components of the circuit arrangement, such as the central controller and the interface to the exchange-internal switching network, are duplicated. The synchronization of the PCM circuits takes place in the interface assembly. The PCM circuits carry both voice channels and signaling channels. Several components such as transformers/framers and buffer memories are required for the synchronization. The buffer memories are used for the voice channels and where timing tolerances occur. No compensation memories are required for the signaling channels. Several of these components are duplicated because of the redundancy requirement. This means that this redundancy requirement has a negative effect with regard to the number of components and is also negative with regard to the component architecture of the complete circuit arrangement.

### SUMMARY OF THE INVENTION

The invention relates to a circuit arrangement for connecting several trunk lines via PCM circuits with a switching network within the exchange, for use in a switching-oriented system, preferably in an electronic data switching system (EWSD) with at least two line and trunk groups (LTG) that form a redundancy pair and have at least one cross-connection, with each line and trunk group having at least one central controller, at least one interface to the exchange-internal switching network, a line circuit area for the PCM circuits and at least one transformer/framer for synchronization for each PCM circuit, with the circuit arrangement being arranged so that a fault occurring in the circuit arrangement affects only a maximum of two PCM circuits.

The invention therefore discloses a novel circuit arrangement for connection of several trunk lines via PCM circuits (data transmission circuits for pulse code modulated signals) to an exchange-internal switching network, for use in a switching-oriented system that with the permissible requirement that in the event of a fault only a maximum of two PCM circuits may be affected has fewer components compared with the circuit arrangement known from the prior art and thus has a substantially more cost-effective construction.

It is possible to save a substantial proportion of components in the circuit arrangement if the sequence of transformers/framers, switching elements and central controller is altered so that the switching elements are arranged before the transformer/framer and the central controller. This therefore means that the switching elements no longer switch the already-transformed signals but instead the PCM circuits.

Accordingly, the invention improves a switching arrangement for connecting several trunk lines via PCM circuits (data transmission circuits for pulse code modulated signals) using an exchange-internal switching network, for use in a switching-oriented system, preferably in an electronic data switching system (EWSD) with at least two line and trunk groups (LTG) that form a redundancy pair and have at least one cross-connection, with each line and trunk group having at least one central controller, at least one interface to the switching network within the exchange, a line circuit area for the PCM circuits and at least one transformer/ framer each for synchronization of the PCM circuits, with the circuit arrangement being configured in such a manner that faults occurring in the circuit arrangement affect only a maximum of two PCM circuits, in such a way that switching elements, that directly and asynchronously select the PCM circuits individually and one of the two central controllers optionally, are positioned before the transformers/framers.

By this means, the LTGs previously necessary in the peripheral interface assemblies, also called digital interface units (DIU), can be omitted. The functions of this interface assembly can now be integrated in the central control system, thus saving costs and space. The only function that is not integrated in the central control system is the switching function of the upstream switching elements. Furthermore, the buffer memory EMU used fur synchronization and buffering for the voice channels can be omitted. This means that the PCM circuits are carried parallel on both central controllers of the line trunk groups and both central controllers have an indirect access to the connected PCM circuits. In the event of failure of one of the central controllers, the central controller still intact can undertake the task of the failed central controller. For example, five PCM circuits can be connected to a first LTG-X and five further PCM circuits to the second LTG-Y, with the LTG-Y being the redundant partner for the LTG-X. If a component of the LTG-X fails, the LTG-Y can connect all of the ten PCM circuits to the switching network within the exchange.

A further improvement is when each upstream switching element has two relays, with one relay being able to switch one PCM circuit. A relay of this kind is provided with two changeover contacts. This means that if a fault occurs within an LTG the effect is felt on only two PCM circuits. In this way, the switching elements meet the same requirements as met previously by the DIU but with a substantially reduced component architecture.

Control of the relays of the upstream switching elements can be advantageously achieved from the central control system by means of a connection that can be a simple signal line. This signal line can at the same time provide the power supply for the relays, with the power source now being located in the central control system of the LTG. This in turn reduces the number of peripheral components and thus the component architecture, and their function is relocated to the central control system.

A further improvement provides for the integration of the physical termination of the PCM circuits into the central control system. There are now two terminating circuits on both LTGs. This means that the active voice channel in the transmission direction is switched in each case to the external PCM circuit.

It is also advantageous if the transformer/framer for synchronization of the PCM circuits is integrated directly into the central control system of the LTGs. This means that the clock synchronization previously necessary between the two LTGs can be omitted. With the circuit arrangement known from the prior art, this clock synchronization is, for example, necessary if the voice channels have to be diverted to the redundant second LTG in the event of failure of one LTG. Furthermore, this change in the component architecture means that the buffer memories for the voice channels, that in the known circuit arrangement were integrated into the interface assemblies and central controllers, are no longer necessary.

A further embodiment of the circuit arrangement is provided in that each line and trunk group, that jointly forms a redundancy pair, has the same number of transformers/framers as the total PCM circuits connected to the redundancy pair. Thus, if five PCM circuits are connected to the LTG-X and five PCM circuits to the LTG-Y, in the event of failure of one LTG, for example LTG-X, the other LTG, i.e. LTG-Y, can switch ten PCM circuits. For this purpose, ten transformers/framers each must be present for the central control system of the LTG-X and LTG-Y.

In this way more transformers/framers overall can be used than with circuit arrangements in accordance with the prior art. The expenditure due to the additional transformers/framers used is, however, substantially lower compared to the overall savings due to the change in the PCM line circuit area.

An advantageous embodiment of the invention provides for the integration of the power supply of the LTG and its surrounding components into the central control system.

In accordance with the basic concepts of the invention, one microprocessor that controls the functioning of the peripheral components can now also be integrated into each central controller of an LTG. This enables expensive coordinating processes between several units to be omitted. Furthermore, the microprocessor previously used, for example in the peripheral interface assemblies, is no longer necessary.

### BRIEF DESCRIPTION OF THE DRAWINGS

Additional features and advantages of the invention are given in the following description of a preferred exemplary embodiment of the circuit arrangement in accordance with the invention, with reference being made to the drawings.

The invention is explained in more detail in the following using drawings. These are as follows:

FIG. 1 shows a conventional circuit arrangement of redundant design for switching-oriented systems.

FIG. 2 shows a circuit arrangement in accordance with the invention for a switching-oriented system.

### DETAILED DESCRIPTION OF THE INVENTION

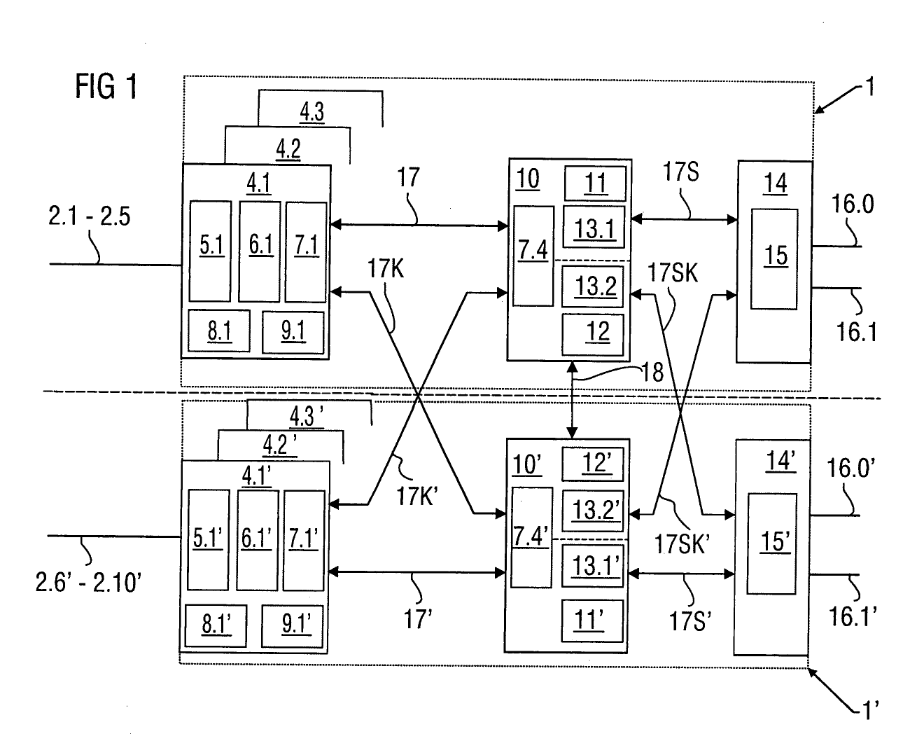

FIG. 1 shows a circuit arrangement of redundant design for switching-oriented systems, such as is known from the prior art. This circuit arrangement includes a redundancy pair, i.e. the line and trunk group also known as LTG-X 1 in the top half of the illustration is also present in the bottom half of the illustration as LTG-Y 1′. In the event of failure of an LTG 1 or 1′, the redundant partner LTG 1′ or 1 takes over the task of the first LTG.

By means of this circuit arrangement, voice channels, signaling channels and control channels 17, 17′ and 17K to 17SK′ can be changed over to a serving circuit arrangement in an electronic data switching system. An LTG 1, 1′ consists mainly of three logic units, the interface assemblies 4.1 to 4.3 and 4.1′ to 4.3′, the central controller 10 and 10′ and the SDC interface 14 and 14′ to the exchange-internal switching network 16.0, 16.1 and 16.0′, 16.1′. These three units and their function are briefly described in the following.

A maximum of two PCM circuits 2.1 to 2.5 and 2.6′ to 2.10′ may be connected to each of the interface assemblies 4.1 to 4.3 and 4.1′ to 4.3′, also known as DIU (Digital Interface Unit). This meets the requirement that in the event of a fault only a maximum of two PCM circuits 2.1 to 2.5 and 2.6′ to 2.10′ may fail. Each interface assembly 4.1 to 4.3 and 4.1′ to 4.3′ has further tasks.

Interface assemblies 4.1 to 4.3 and 4.1′ to 4.3′ thus function as the physical termination for the PCM circuits 2.1 to 2.5 and 2.6′ to 2.10′. Furthermore, synchronization of the data signals takes place in the transformer/framer 5.1 to 5.3 and 5.1′ to 5.3′. One interface assembly each 4.1 to 4.3 and 4.1′ to 4.3′ has its own switch, also known as switch 6.1 to 6.3 and 6.1′ to 6.3′, to route the voice and signaling channels 17, 17′ and 17K, 17K′ to the central controllers 10 and 10′.

A microprocessor 8.1 to 8.3 and 8.1′ to 8.3′ for each interface assembly 4.1 to 4.3 and 4.1′ to 4.3′ controls the functions of the particular interface assembly 4.1 to 4.3 and 4.1′ to 4.3′ and processes the incoming line signals. To compensate for timing tolerances between LTG-X 1 and LTG-Y 1′, each interface assembly 4.1 to 4.3 and 4.1′ to 4.3′ has its own buffer memory 7.1 to 7.3 and 7.1′ to 7.3′. These buffer memories 7.1 to 7.3 and 7.1′ to 7.3′ are required for voice channels 17, 17′ and 17K, 17K′. Interface assemblies 4.1 to 4.3 and 4.1′ to 4.3′ each have their own power supply 9.1 to 9.3 and 9.1′ to 9.3′. The interface assemblies 4.1 to 4.3 and 4.1′ to 4.3′ are connected to the central controller 10 and 10′ of LTG 1 and 1′ as peripheral devices.

The central controllers that, as a redundancy pair 10 and 10′ are responsible for LTG-X 1 and LTG-Y 1′, enable five PCM circuits 2.1 to 2.5 and 2.6′ to 2.10′ to be connected in each case and the voice channels contained therein to be passed on to the relevant exchange-internal switching network 14 or 14′.

Each central controller 10 and 10′ has a group processor 11 and 11′. By means of switches 13.1, 13.2 and 13.1′, 13.2′, also known as a group switch, voice channels 17SK, 17SK′ can, as cross-connections, be switched in the event of a fault in a central controller, for example from 10 to the other central controller 10′. These switches 13.1, 13.2 and 13.1′, 13.2′ are controlled by microprocessor 12 or 12′ operated between the peripheral components. The group processor 11 of one central controller 10 operates together with the other group processor 11′ of the other central controller 10′ via the link 18. Similar to interface assemblies 4.1 to 4.3 and 4.1′ to 4.3′, the central controllers 10 and 10′ each have their own buffer memory 7.4 and 7.4′. These buffer memories 7.4 and 7.4′ serve to synchronize and buffer the data in the event of timing tolerances occurring in the voice channels 17, 17′ and 17K, 17K′. The central controllers 10 and 10′ are connected via the switching network interfaces 14 and 14′ to the duplicated switching networks 16.0, 16.1 and 16.0′, 16.1′.

The voice channels and control data can, as a cross-connection 17SK, 17SK, also be routed crossed from switches 13.1, 13.2 and 13.1′, 13.2′ of central controllers 10 and 10′ to the duplicated switching networks 16.0, 16.1 and 16.0′, 16.1′. The switching network interfaces 14 and 14′ function as a link between the central controllers 10, 10′ and the exchange-internal switching networks 16.0, 16.1 and 16.0′, 16.1′, with each SDC interface 14, 14′ having its own switch 15 and 15′ for selecting the active voice and control channel 17S, 17S′ and 17SK, 17SK′.

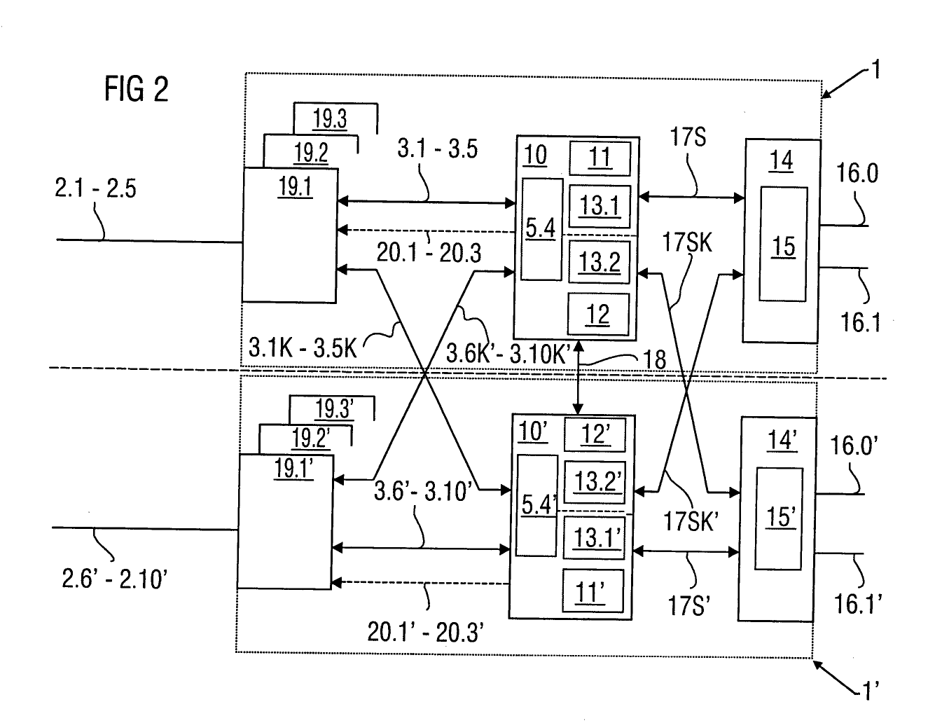

FIG. 2 shows a circuit arrangement in accordance with the invention for a switching-oriented system. The essential difference between the new circuit arrangement and the circuit arrangement in FIG. 1 is that the peripheral interface assemblies (DIU) previously used in the PCM line circuit area can be omitted. The necessary components of the interface assemblies were relocated to the central controllers 10 and 10′. This change in the component architecture results in a simplification in the synchronization of the PCM circuits. With the new circuit arrangement, the buffer memories can also be omitted and synchronization of both LTGs 1, 1′ is made easier.

This circuit arrangement also includes two LTGs 1 and 1′ that form a redundancy pair. One LTG 1, 1′ has the re-configured PCM line circuit area, a changed central controller 10 and 10′ and the switching network interface 14 and 14′. These components of the circuit arrangement are described in the following.

In the PCM line circuit area, the PCM circuits 2.1 to 2.5 and 2.6′ to 2.10′ connected to the LTG are connected in parallel, as LTG internal PCM circuits 3.1 to 3.5 and 3.6′ to 3.10′, to central controllers 10 and 10′. A maximum of two PCM circuits 2.1 to 2.5 and 2.6′ to 2.10′ are each connected to a relay from 19.1 to 19.3 and 19.1′ to 19.3′ with two switching contacts in each case. To explain: for example, 19.1 therefore includes two relays. Via relays 19.1 to 19.3 and 19.1′ to 19.3′, a PCM circuit can then be controlled and switched directly and asynchronously to central controllers 10 and 10′. The PCM signals are thus fed unchanged to central controllers 10 and 10′. In this case there is also a difference with respect to the circuit arrangement in FIG. 1 in that the PCM circuits are supplied already synchronized to the central controllers 10.1 and 10.2. Relays 19.1 to 19.3 and 19.1′ to 19.3′ are supplied with power and controlled from both central controllers 10 and 10′ of the LTGs. The relays enable a cross-connection of the PCM circuits 3.1K to 3.5K and 3.6K′ to 3.10K′ to both LTGs 1 and 1′ to be established.

The central controllers, that as a redundancy pair 10 and 10′ are responsible for LTG-X 1 and LTG-Y 1′, enable five PCM circuits 3.1 to 3.5 and 3.6′ to 3.10′ to be connected in each case and the voice channels contained therein to be passed on to the relevant switching network interface 14 or 14′.

In contrast to FIG. 1, the new circuit arrangement does not require buffer memories in the central controllers 10 and 10′ for the voice channels of the PCM circuits 3.1 to 3.5 and 3.6′ to 3.10′. The PCM circuits are synchronized via transformers/framers 5.4 and 5.4′. In FIG. 2, a total of ten PCM circuits (2.1 to 2.5 and 2.6′ to 2.10′) are connected to the redundancy pair. A total of ten transformers/framers 5.4 are present in LTG-X 1 and a total of ten transformers/framers 5.4′ in LTG-Y 1′. The transformers/framers 5.4 and 5.4′ are now arranged directly in the central controller 10 and 10′ of LTG-X 1 and LTG-Y 1′.

The result of this is that an expensive clock synchronization between both LTGs can be omitted. Microprocessor 12 and 12′ of central controller 10 and 10′ performs the task of microprocessor 8.1 to 8.3 and 8.1′ to 8.3′, that in the circuit arrangement in FIG. 1 was responsible for the control of interface assemblies 4.1 to 4.3 and 4.1′ to 4.3′. Only one microprocessor 12 and 12′ for each LTG 1, 1′ is thus required for the peripheral functions.

Voice channels 17SK, 17SK′ can also be cross routed by means of switches 13.1, 13.2 and 13.1′, 13.2′ of central controllers 10 and 10′ to the duplicated switching networks 16.0, 16.1 and 16.0′, 16.1′. The switching network interfaces 14 and 14′ function as a link between central controllers 10, 10′ and switching networks 16.0, 16.1 and 16.0′, 16.1′, with each of these SDC interfaces 14, 14′ having its own switch 15 and 15′ for selecting the active voice and signaling channel 17S, 17S′ and 17SK, 17SK′.

Overall therefore, the invention provides a switching arrangement for connecting several trunk lines via PCM circuits to an exchange-internal switching network for use in a switching-oriented system. This switching arrangement is of redundant design and, in the event of a fault occurring in a component of the switching system, meets the requirement that two PCM circuits may be affected. Compared with previously known circuit arrangements of this kind, this new circuit arrangement has a smaller number of components and a re-configured component architecture in the line circuit area of the PCM circuits. Because with this new circuit arrangement peripheral components and thus their function are relocated to the central controllers, fault location and rectification are made very much easier when a fault occurs.

What is claimed is:

1. A circuit arrangement for connecting trunk lines via PCM circuits to an exchange-internal switching network, for use in a switching-oriented system, comprising:
at least two line and trunk groups that form a redundancy pair and have at least one cross-connection, with each line and trunk group having at least one central controller;
at least one interface to the exchange-internal switching network;
a line circuit area for the PCM circuits;
at least one transformer/framer for synchronization for each PCM circuit, wherein the circuit arrangement is configured such that a fault occurring in the switching arrangement affects a maximum of two PCM circuits; and
switching elements, that directly and asynchronously select the PCM circuits individually and one of the two central controllers optionally, are positioned before the transformers/framers.

2. The circuit arrangement in accordance with claim 1, wherein each of the upstream switching elements has two relays, with one relay being able to switch a PCM circuit.

3. The circuit arrangement in accordance with claim 1, wherein control of the upstream switching elements is achieved by the central controller.

4. The circuit arrangement in accordance with claim 1, wherein the transformer/framer for synchronization of the PCM circuits is integrated into the central controller.

5. The circuit arrangement in accordance with claim 1, wherein each line and trunk group, that together forms a redundancy pair, has as many transformers/framers as the total PCM circuits connected to the redundancy pair.

6. The circuit arrangement in accordance with claim 1, wherein a power supply of the line and trunk group and its surrounding components are integrated into the central controller.

7. The circuit arrangement in accordance with claim 1, wherein one microprocessor, that controls the functions of surrounding components, is arranged at each line and trunk group.
